(19) United States
(12) Patent Application Publication
(10) Pub. No.: US 2024/0000250 A1
(43) Pub. Date: Jan. 4, 2024

(54) SPACE EXPANSION BEVERAGE GLASS AND STORAGE MEDIUM

(71) Applicant: Netappli Co., Ltd., Kahoku-gun (JP)

(72) Inventor: Makoto NISHIDA, Kahoku-gun (JP)

(21) Appl. No.: 18/466,388

(22) Filed: Sep. 13, 2023

Related U.S. Application Data
(63) Continuation of application No. PCT/JP2021/047155, filed on Dec. 21, 2021.

(30) Foreign Application Priority Data
Mar. 15, 2021 (JP) 2021-076805

(51) Int. Cl. A47G 19/22; G06T 11/60; G06T 3/40; G06T 11/00

(52) U.S. Cl. CPC A47G 19/2227; G06T 11/60; G06T 3/40; G06T 11/001; A47G 2019/2277

(57) ABSTRACT

A space expansion beverage glass comprises a glass body with an upper opening, a fixing mechanism that fixes a picture display device to a side of the glass body, a transparent part that is made of a transparent material, an image control part that displays a human image and a background image to the picture display device, and a sensor. The image control part displays or outputs a composite image in which the background image is combined with a background portion of an human image to the picture display device, in the composite image, the human image is drawn in an area where the human image and the background image overlap, a size of the human image relative to the background image is changed due to a signal from the sensor, the user views the composite image through a beverage inside the glass body and the transparent part.

### CROSS REFERENCE TO RELATED APPLICATIONS

This application is a continuation of a PCT application No. PCT/JP2021/047155 filed on Dec. 21, 2021, which is based on and claims priority to Japanese Patent Applications No. 2021-076805 filed on Mar. 15, 2021, the disclosures of which are incorporated herein by reference.

### TECHNICAL FIELD

The present invention relates to a space expansion beverage glass by which the space inside the beverage glass is expanded into a vast space as seen from user's eyes, and a storage medium used therein.

### BACKGROUND

Glasses with various functions other than the function to contain beverages have been developed, one of which is a beverage entertainment glass with a reflecting mirror(s) placed inside, and another of which is a beverage entertainment glass that cancels an image distortion caused by a lens effect of beverage.

For example, Patent Document 1 discloses a beverage entertainment glass invented by the inventor of the present application. The beverage entertainment glass is equipped with a picture display device fixed to a glass side and a reflecting mirror arranged inside a glass body, and a picture of the picture display device is projected inside the glass in a pseudo manner.

Patent Document 2 discloses another beverage entertainment glass invented by the inventor of the present application. The beverage entertainment glass outputs a squeezed image that is compressed in a horizontal direction using a picture aspect ratio control part that controls the aspect ratio of the image, and offsets or cancels the distortion of the image due to the lens effect of the beverage inside the glass body.

### RELATED ART

### Patent Documents

[Patent Document 1] JP Patent No. 6488049
[Patent Document 2] JP Patent No. 6749668

### Problem(s) to be Solved

These beverage entertainment glasses of Patent Documents 1 and 2, however, cannot expand the space inside the glass including the bottom of the glass into a vast space. Also, it is not possible to interact with a human in a vast space inside the glass that is developed or depicted in the glass.

In view of the above problems, an object of the present invention is to provide a space expansion beverage glass that expands the size of the space inside the glass body including the bottom of the glass as seen from the user's eyes.

Further, another object of the present invention is to provide a storage medium storing a computer program for use in the space expansion beverage glass.

### SUMMARY

A space expansion beverage glass disclosed in the application comprises a glass body that is a bottomed tubular body with an upper opening, a fixing mechanism that is configured to fix a picture display device to a side of the glass body, a transparent part that is made of a transparent material allowing a user to view an image of the picture display device from an outside of the glass body, an image control part that is configured to display or output a human image and a background image to the picture display device, and a sensor, wherein the human image is a computer graphic image representing a human or a fictitious human having a face including eyes and a mouth, the image control part displays or outputs a composite image in which the background image is combined with a background portion of the human image to the picture display device, in the composite image, the human image is drawn in an area where the human image and the background image overlap, a size of the human image relative to the background image is changed due to a signal from the sensor, the user views the composite image through a beverage inside the glass body and the transparent part.

The space expansion beverage glass further may comprise a reflecting minor that is configured to reflect the composite image in a direction of the upper opening, and is provided inside the glass body or near a bottom of the glass body, wherein after the composite image is reflected off the reflecting mirror, the composite image reaches an outside of the glass body through the upper opening.

The sensor may be configured to monitor an operation of the user on the glass body or the picture display device, when the sensor detects a predetermined operation on the glass body or the picture display device, the sensor transmits the signal to the image control part, and the image control part changes the size of the human image relative to the background image in response to the signal.

The image control part may be computer software or a computer program.

The image control part may be computer software or a computer program that is implemented inside a housing of the picture display device, and the image control part changes the composite image in correspondence with a value of signal of the sensor.

The sensor may be one of a camera sensor, an acceleration sensor, a microphone, a piezoelectric sensor, a touch panel, a sugar level sensor, and an alcohol sensor.

The sensor may be an acceleration sensor that is configured to detect acceleration of the glass body, when the acceleration sensor detects a predetermined acceleration of the glass body, the acceleration sensor transmits the signal to the image control part, and the image control part changes the size of the human image relative to the background image in response to the signal.

The background image may be an image in which a color is used, having either lower luminance or lower brightness compared to the human image.

The reflecting minor may be arranged such that the reflecting minor faces parallel to the picture display surface, which is arranged in the same direction as a longitudinal direction of the glass, and the reflecting mirror tilts at about 45 degrees with respect to the picture display surface from a lateral viewpoint.

A storage medium, which is disclosed in the present application, stores a computer program used in the space expansion beverage glass, wherein the computer program displays or outputs the composite image in which the background image is composited behind or in a background portion of the human image.

The computer program may change a size of the human image relative to the background image due to a signal of the sensor, and the computer program displays or outputs the composite image in which the background image is composited behind or in a background portion of the human image.

The computer program may change a size of the human image relative to the background image due to a signal of the sensor, the computer program reverses the human image and the background image vertically or horizontally, and the computer program displays or outputs the composite image in which the background image is composited behind or in a background portion of the human image.

The computer program may change a size of the human image relative to the background image due to a signal of the sensor, the computer program reverses the human image and the background image vertically and horizontally, and the computer program displays or outputs the composite image in which the background image is composited behind or in a background portion of the human image.

### Advantage(s) of the Present Invention

According to one embodiment of the space expansion beverage glass of the present invention, such a glass greatly expands the space or volume inside the glass body as seen from the user's eyes in comparison to the actual glass body (or the actual size of glass).

People (or users) can recognize or infer the size of a drawn room or drawn space (together with the human in an illustration) from an illustration or a portrait of a human in which the human in the room is drawn by perspective or Perce method. Therefore, by simultaneously projecting a human image and a background image using the picture display device provided either on the side or bottom of the glass body, it is possible to create an illusion in the user's brain that the space or volume inside the glass body has expanded.

In the space expansion beverage glass of the present invention, the user can freely adjust the size of the space in the glass body (perceived or felt by the user) at any time by changing a relative size of the human image with respect to the background image.

In the space expansion beverage glass of the present invention, when the glass is tilted (during a toasting motion, etc.), it is possible to create a toast entertainment such as expanding or shrinking the space inside the glass body by changing the relative size of the human image with respect to the background image using a sensor such as an acceleration sensor or a camera sensor as a trigger.

In the space expansion beverage glass of the present invention, by using a sensor such as a camera sensor or a microphone sensor, it is possible to create a toast entertainment (toast performance) such as expanding or shrinking the space inside the glass body, which is recognized or felt by the user at a timing when the inside of the glass body is filled with the beverage.

In the space expansion beverage glass of the present invention, the user can communicate interactively with a human or fictional character who is in a vast space regenerated inside the glass body in a pseudo manner by computer graphics via a touch panel, a button sensor, or a microphone.

In the space expansion beverage glass of the present invention, by arranging a reflecting minor either inside or on the bottom of the glass, not only the space on the side of the glass but also the space on the bottom of the glass can be pseudo-expanded. This gives the user the illusion that a vast space is spreading inside the glass not only on the sides of the glass, but also when looking into the bottom of the glass through the upper opening of the glass.

In the space expansion beverage glass of the present invention, the user can create a pseudo-enlarged space that is visually recognized through the beverage in the glass body so that the color of the beverage can be used to color the space for the entertainment.

In the space expansion beverage glass of the present invention, the user can create a pseudo-enlarged space that is visually recognized through the beverage in the glass body so that a human floating in the space inside the babbles of the carbonated beverage can be generated.

The space expansion beverage glass of the present invention can expand the space at the bottom of the glass by using a reflecting mirror and a composite image that creates an illusion of the user's perspective. One of the main advantages is to provide the user with an experience of a unique floating feeling when the user sees the bottom of the beverage while drinking the beverage.

### BRIEF DESCRIPTION OF THE DRAWINGS

FIG. 1 is a perspective view showing a space expansion beverage glass according to the first embodiment.

FIGS. 2A and 2B are perspective views. FIG. 2A shows an example of a human image without a sensor signal and FIG. 2B shows an example of a human image with a sensor signal.

FIG. 3A is a perspective view and FIG. 3B is an upper cross sectional view showing a space expansion beverage glass according to the second embodiment.

FIG. 4A is a perspective view and FIG. 4B is a cross sectional view showing an example in which a reflecting mirror and the bottom of the glass are integrated.

FIG. 5 is a flowchart diagram of a computer program for an image control part.

FIG. 6 is a flowchart diagram of another computer program for the image control part including resizing (or size changing) a human image with respective to a background image.

FIG. 7 is a flowchart diagram of another computer program including an image reversal processing.

### DETAILED DESCRIPTIONS OF THE PREFERRED EMBODIMENTS

[First Embodiment of Space Expansion Beverage Glass]

The first embodiment of the space expansion beverage glass of the present invention is described below with reference to the drawings.

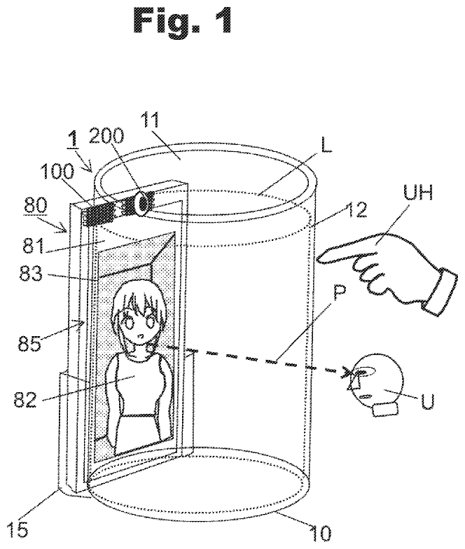

As shown in FIG. 1, space expansion beverage glass 1 is mainly composed with following: glass body 10 that is a bottomed tubular body having upper opening 11, fixing mechanism 15 that is configured to fix picture display device 80 to glass body 10, transparent part 12 through with the image of picture display device 80 (specifically, picture display surface 81) is viewed from the outside, and image control part 100 that displays or outputs human image 82 and background image 83 on picture display device 80, and sensor 200.

Glass body 10 is a bottomed tubular body having upper opening 11. Examples of the shape of glass body 10 include a normal cup shape as shown in FIG. 1, a beer mug shape (or a mug cup shape) with a handle, a bottle shape having a lid that closes upper opening 11, and the like. Examples of the material of glass body 10 include glass and transparent resin etc. The inside of glass body 10 is expected to be filled with beverage L.

Fixing mechanism 15 is a fixing mechanism that is configured to fix picture display device 80 to glass body 10. In the example of FIG. 1, a storage part provided with the glass body 10 is used as fixing mechanism. Any type of fixing mechanism may be used as fixing mechanism 15 as long as it can fix picture display device 80 to glass body 10. Fixing mechanism 15 may be a combination of a screw mechanism, a sucker mechanism, and the like. The material of fixing mechanism 15 is not particularly limited, but a transparent material is desirable so as not to block picture display surface 81 of picture display device 80.

Transparent part 12 is a transparent section provided on the side surface of glass body 10 so that picture display surface 81 of picture display device 80 is visually recognized from the outside. Examples of materials of transparent part 12 include transparent glass and transparent resin such as acrylic. User U visually recognizes an image projected on picture display device 80 or picture display surface 81 through transparent part 12 passing over beverage L inside glass body 10 from the outside of glass body 10. Broken line P in FIG. 1 indicates an object to explain an image of a light path of light of an image projected from picture display device 80 (more precisely, (a composite image 85 of human image 82 and background image 83). As shown with light path P, the image displayed on the picture display device 80 reaches the outside of glass body 10 by penetrating (or passing through) beverage L and transparent part 12.

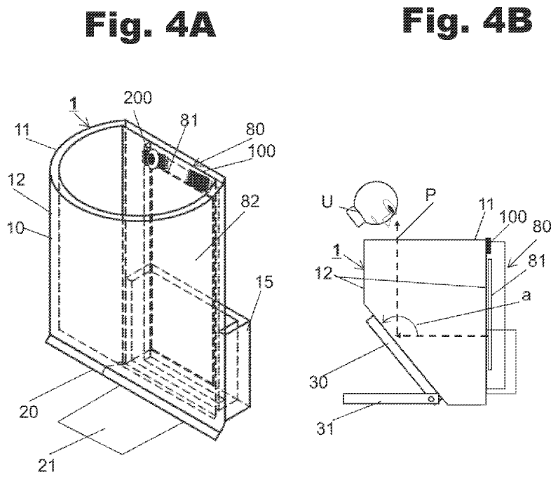

As shown in FIG. 4A, transparent part 12 of the side surface of glass body 10 may be formed with a combination of a flat surface and a curved surface to allow the image of picture display device 80 to pass through. The reason for having the flat surface is to prevent distortion of the image due to scattering of the light of the image caused by light refraction.

Picture display device 80 can be realized using devices that display a picture, a video and an image, such as liquid crystal displays (LED), organic EL displays and LED displays. Picture display surface 81 means a surface of the picture display device 80 on which these picture, video and image are displayed.

Image control part 100 displays or outputs composite image 85, which is generated by compositing background image 83 to the background portion of human image 82, on picture display device 80 (more specifically, picture display surface 81). In space expansion beverage glass 1 of the present invention, the size of the space inside the glass body visually recognized by user U is changed by changing the relative size of human image 82 with respect to background image 83. In other words, by changing the size of human image 82 drawn on the front side of background image 83 (as viewed from user U), the size of the space inside the glass body recognized by user U is given different than it actually is, based on the perspective principle. Image control part 100 may be embedded in the bottom surface or inside the wall surface of glass body 10 in the form of a dedicated IC, ASIC, or the like. Further, image control part 100 may be implemented as computer software or a computer program inside the housing of picture display device 80 or at an outside computer as long as composite image 85 can be output or displayed.

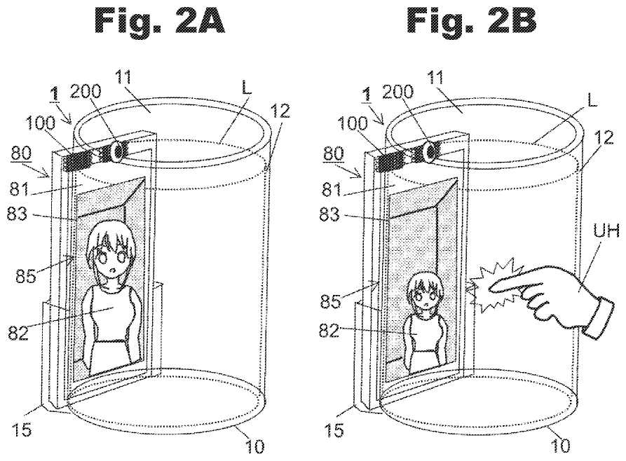

Sensor 200 is used as a trigger to change the relative size of human image 82 (in composite image 85) with respect to background image 83. Sensor 200 may be any type of sensor that is configured to monitor operations of user U on glass body 10 (or picture display device 80). As sensor 200, an acceleration sensor, a camera sensor, a microphone, a sugar degree sensor, an alcohol sensor, a piezoelectric sensor, a touch panel sensor, etc. can be practical. In the examples of FIGS. 2A and 2B, sensor 200 is a camera sensor or an acceleration sensor. Using a camera sensor (or an acceleration sensor) attached to the top of glass body 10 or picture display device 80 as sensor 200, the contact or collision between glass body 10 and user's hand UH is monitored, the relative size of human image 82 (in composite image 85) with respect to background image 83 is changed depending on the presence or absence of the contact between glass body 10 and user's hand UH. In the example of FIG. 2B, with the signal from sensor 200 (strictly, a contact detection signal between user's hand UH and glass body 10), the relative size of human image 82 with respect to background image 83 is determined to be smaller than it actually is (when the sensor is not detected) such that a vast space appears on the side of glass body 10 (based on the perspective principle) (that is, the contact between glass body 10 and user's hand UH is used as a trigger to change the size of the space inside the glass). In this way, with space expansion beverage glass 1 of the present invention, because sensor 200 is provided, the side of the space inside glass body 10 (that is a visually recognized side from the user's eyes) can be changed at an arbitrary timing (e.g., timing of toasting motion) depending on whether the contact between glass body 10 and user's hand UH is detected or not. An acceleration sensor may be used as sensor 200 to monitor the strength of collision of user's hand UH (for example, the strength of collision between glasses in a toasting motion) and the relative size of human image 82 with respect to background image 83 can be changed according to the monitored strength (or monitored value). Sensor 200 may be placed at the bottom part of glass body 10 or inside fixing mechanism 15 (or storage part). Further, a sensor embedded on the housing side of picture display device 80 may be used as sensor 200.

Supplementary descriptions of human image 82, background image 83, and composite image 85 obtained by compositing them are given below.

By using a size of human in front of themselves as a standard reference, people can recognize an approximate size of the room or space in which the human in front of them is present based on the perspective principle. In the same way, people can recognize or infer relative size of a room (along with the human) drawn in an illustration by referring to the size of the human drawn in the illustration or the portrait in the room. (It is noted that manga and portraits have used such a technique since old days to express the size of a room or space in which the human exists. For details, see text books of perspective method and Perce method. In space expansion beverage glass 1 of the present invention, the size of the space inside the glass body visually recognized by user U is changed by changing the relative size of human image 82 with respect to background image 83 (namely, making the human smaller or the background larger in order to enlarge the relative size). In other words, space expansion beverage glass 1 is a glass that, by individually changing the sizes of background image 83 and human image 82 in composite image 85, creates an illusion that the side of the space inside the glass body has been greatly expended, as shown in the example in FIG. 2B, based on the perspective principle.

Space expansion beverage glass 1 changes the size of the space inside glass body 10 (recognized or perceived by user U) through the perspective method that uses the relative sizes of human image 82 and background image 83. Based on such a principle, the smaller the size of human image 82 compared to the size of background image 83 is, the larger the size of the space inside glass body 10 (recognized or perceived by user U) is perceived. Therefore, by reducing the size of human image 82 to the extent that the resolution of picture display device 80 permits, the space inside glass body 10 can be enlarged as much as user U desires (strictly speaking, it is possible to make the user recognize or view as if the space has been enlarged). This is one of the advantages of space expansion beverage glass 1.

Human image 82 is a computer graphic representation of a human or a fictitious human having a face including eyes and a mouth. Examples of human images 82 include computer-graphic images of fictional humanoid characters from comic books or animated works, or computer-graphic images of real people, such as movie actors. As long as human image 82 includes the face, user U (more strictly speaking, a section in which visual information in the brain of user U is processed) can recognize perspective by contrasting it with background image 83. Therefore, human image 82 does not necessarily have to be a full-body image can be used as the human image). (In other words, in principle, human image 82 may be image that user U recognize as a human face in the user's brain.)

Background image 83 may be any image as long as it represents a space (or a room) in which human image 82 exists. An example of background image 83 may be a computer graphic image representing an interior of room. Another example of background image 83 may be a computer graphic image representing underwater, city sight, outer space, air etc. In extreme cases, background image 83 may be any image as long as the boundary between human image 82 and background image 83 can be recognized or distinguished when background image 83 is combined with human image 82. For example, a tone image consisting of a repetition of a single pattern or an image filled with a single color may be used as background image 83 (in the illustration field of manga, cartoons and comic book, a tone image consisting of a repetition of a single pattern or background images filled with a single color have been used as a method of depicting a room or space where people exist. Especially, such a method has been used since computer photo retouching software was developed). Additionally, in order to enhance the perspective feeling sensed by the user, the background image 83 may be an image using a color with a lower brightness or luminance than (the color used in) those of human image 82 (that is, background image 83 may be darker than human image 82).

Supplementary descriptions of composite image 85 is here. In composite image 85 of space expansion beverage glass 1 of the present invention, human image 82 is drawn (with priority) in an area where human image 82 and background image 83 overlap (that is, human image 82 is always drawn on the front side of background image 83 as seen from user U). It is noted that, when creating composite image 85, background image 83 may be composited behind human image 82 or in the margin.

Composite image 85 is an image displayed by light-emitting elements of picture display device 80 (strictly speaking, picture display surface 81). User U can visually recognize composite image 85 over beverage by increasing the output of brightness of picture display device 80 even when the beverage is colored with thick color (for example, red of red wine). That is because composite image 85 is not an image printed on paper but a luminous image.

Space expansion beverage glass 1 changes (or expands) the size of the space inside the glass by simply changing the relative size of human image 82 and background image 83. Therefore, the processing load on image control part 100 or the computer is low and heat dissipation is low so that it does not necessary to worry about beverage L being heated.

In space expansion beverage glass 1, picture display device 80 is provided on the side surface of glass body 10. User U can see composite image 85, which is a composite of human image 82 and background image 83 on picture display device 80 (strictly speaking, picture display surface 81), through beverage L in glass body 10. Therefore, user U can view a fictitious humanoid character from manga (cartoon) or animation work who is swimming in a vast space within beverage L in glass body (which has emerged based on the perspective principle).

In space expansion beverage glass 1, it is also possible to communicate interactively with a fictitious character (of human image 82) in beverage L with sensor 200. For example, when an acceleration sensor that detects the inclination of glass body 10 is used as sensor 200, by tilting glass body 10 in a toasting operation, it is possible to manipulate a fictional humanoid character or human swimming in the vast deep sea appeared inside beverage L.

When a camera sensor is used as sensor 200, the size of the room represented by composite image 85 of human image 82 and background image 83 can be changed in correspondence with the color of beverage L.

When an alcohol sensor or a sugar sensor is used as sensor 200, the size of the room represented by composite image 85 of human image 82 and background image 83 can be changed in correspondence with sugar degree or alcohol concentration of beverage L, which is sensed by the sensor. The facial expression of human image 82 may be changed in correspondence with the value of alcohol concentration.

When a sound sensor such as a microphone etc. is used as sensor 200, and in a case where drink L is a carbonated drink, it is possible to detect the bubbling sound of the carbonated drink and manipulate the size of the vast room and a fictitious human that has emerged in beverage L.

In space extension beverage glass 1, as shown in FIG. 1, user U visually recognizes human image 82 through beverage L. Therefore, when an astronaut or a scuba diver is selected as the character of human image 82, it is effect at the drinking time from a perspective of entertainment (It is also noted that, originally, space expansion beverage glass 1 of the present invention was developed with the aim of being a beverage presentation glass that can communicate interactively with a human swimming in the vast space in beverage L via a touch panel sensor or a microphone sensor).

[Second Embodiment of Space Expansion Beverage Glass]

Hereinafter, the second embodiment of the space expansion beverage glass of the present invention is shown with reference to the drawings. The same symbols are used for parts that have the same configuration as space expansion beverage glass 1 of the first embodiment above, and their explanations are omitted.

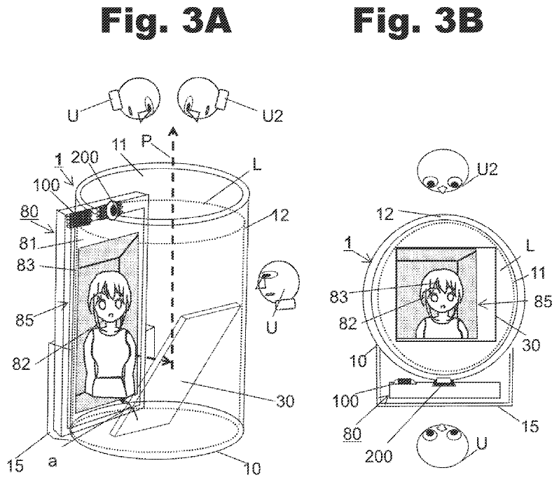

As shown in FIG. 3A and FIG. 4A, in space expansion beverage glass 1 of the present embodiment, reflecting mirror 30 that is configured to reflect composite image 85 displayed on picture display device 80 in a direction of upper opening 11 of glass body 10 is provided either inside or near the bottom of glass body 10.

As shown in FIG. 3A, reflecting minor 30 placed in glass body 10 is placed with an inclined manner with respect to picture display surface 81 or upper opening 11 to reflect composite image 85 displayed on picture display device 80 (or picture display surface 81). As shown in FIGS. 3A and 3B, user U visually recognizes composite image 85 through upper opening 11. Since composite image 85 is an image that creates the illusion of perspective of user U who combines human image 82 and background image 83 in its brain, the spatial size of the side surface of glass body 10 and the spatial size of the bottom of glass body 10 are expanded simultaneously in space expansion beverage glass 1 of the present embodiment. (Strictly speaking, it is possible to create an illusion of perspective for user U with composite image 85 as if the space of the side surface and the bottom surface of glass body 10 are expanded). Light path P in FIG. 3A is an image diagram of the projection light path of composite image 85 output from picture display device 80. In this embodiment of space expansion beverage glass 1, as shown in light path P in FIG. 3A, after composite image 85 (projected from picture display device 80) is reflected by reflecting mirror 30, composite image 85 passes through upper opening 11 to reach the outside of the glass body.

In this embodiment of space expansion beverage glass 1, the space inside glass body 10 on the bottom is also expanded. Therefore, when a camera sensor or the like is used as sensor 200 to detect or monitor the motion of user U looking into glass body 10, it is also possible to develop a vast space on the bottom of glass body 10 at a timing when the user U looks into glass body 10 for drinking.

When drinking an alcoholic beverage as beverage L using space expansion beverage glass 1 of the present embodiment, user U can experience a unique floating feeling due to synergistic effect(s) of the expansion space on the bottom of glass body 10 by reflecting mirror 30 and composite image 85 (that creates the illusion of perspective of user U) and the floating feeling caused by the alcoholic beverage. This unique floating feeling caused by the alcoholic beverage and the expansion space on the glass bottom is one of the greatest features of space expansion beverage glass 1 of the present embodiment. In particular, this floating feeling becomes strongest when the face of user U is close to or in almost contact with upper opening 11 (that is, when the distance between reflecting mirror 30 and user U is the shortest). User U can obtain a strong floating feeling every time the user looks into upper opening 11 when drinking beverage L inside glass body 10. As a method for further enhancing the floating feeling, there are several options following: setting background image 83 an image that expresses a vast space such as outer space, underwater, or air; setting background image 83 a moving image (or video); and changing the size of human image 82 rapidly due to signal(s) of sensor 200.

Supplementary descriptions regarding an arrangement position of reflecting mirror 30 in glass body 10 is given below. Reflecting minor 30 does not necessarily have to be placed inside glass body 10 as shown in FIG. 3A. As long as it can reflect composite image 85 in the direction of upper opening 11, reflecting mirror 30 may be placed at any position in glass body 10. For example, as shown in FIGS. 4A and 4B, it may be adhered to the bottom surface of glass body 10 or integrated with the bottom surface (glass body 10 shown in FIGS. 4A and 4B is assumed to be made of a transparent material). Further, to supplement the angle (a) between reflecting minor 30 and picture display device 81, an ideal angle (a) between reflecting minor 30 and picture display device 81 (or upper opening 11) is ranged between 43 degrees and 47 degrees. When the angle (a) is significantly different from 45 degrees, composite image 85 that is viewed by user U through reflecting minor 30 is stretched and distorted in the vertical direction. In this point, when installing reflecting minor 30 into glass body 10, the angle (a) is required to be adjusted carefully.

Reflecting mirror 30 is arranged such that the minor faces (parallel to) picture display surface 81, which is arranged in the same direction as the vertical/longitudinal direction of glass body 10. Furthermore, reflecting minor 30 is arranged such that the mirror tilts at about 45° (within the range from 43 to 47 degrees) from the lateral (or horizontal) viewpoint.

In the practical point, reflecting mirror 30 does not have to be placed directly on the bottom surface of glass body 10. Reflecting minor 30 may be placed near (in the vicinity of) the bottom surface. For example, a small gap (1 to 5 mm) may be created between the minor and the bottom surface. Further, the small gap may be ranged within 10% with respect to the longitudinal length of glass body 10 so that design freedom of the invention enhances. In a case that the small gap is greater than 10%, it is getting difficult to reflect the image physically.

Depending on the orientation of the user U's viewpoint, the orientation of composite image 85 may be vertically reversed or horizontally reversed with respect to user U1 like composite image 85 viewed from the viewpoint of user U2 in FIG. 3B. Human image 82 and background image 83 in composite image 85 may be vertically reversed or horizontally reversed in advance using image control part 100 or separate computer software etc. Sensor 200 (camera sensor or the like) may be used to monitor (monitor) the orientation of user U's viewpoint in real time, and composite image 85 may be vertically reversed or horizontally reversed in accordance with it.

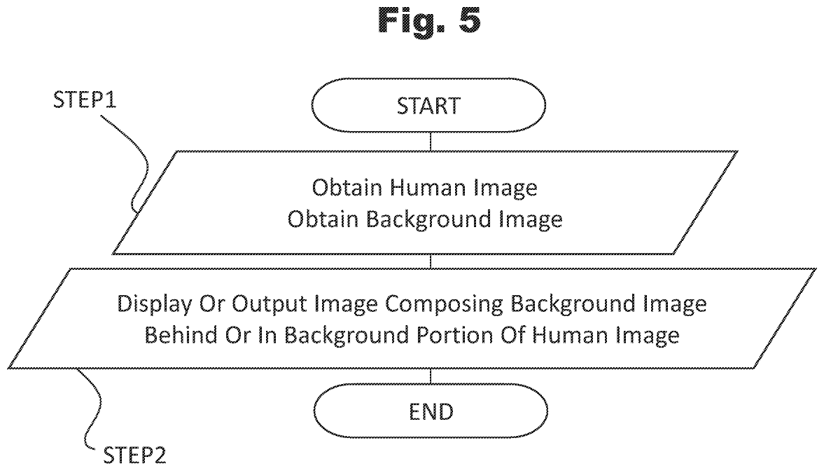

FIG. 5 shows a flowchart of a computer program used in space expansion beverage glass 1 of the present invention.

In STEP 1, human image 82 and background image 83 are obtained from a computer memory. In STEP 2, an image generated by synthesizing background image 83 behind or in the background of human image 82 is displayed or output on picture display device 80, and then the program ends.

A supplementary explanation for STEP 1 is added below. The data of human image 82 and background image 83 may be stored in and obtained (downloaded) from a computer memory in picture display device 80, a computer memory in a USB storage medium, a computer memory in an IC chip, and a computer memory in a cloud server etc. It may be obtained (or downloaded) from a memory or the like.

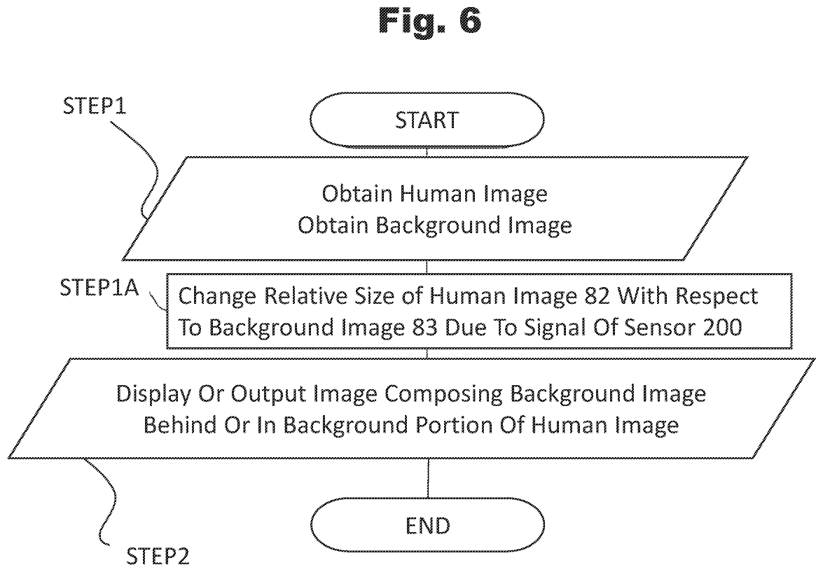

FIG. 6 shows a flowchart of another computer program used in space expansion beverage glass 1 of the present invention.

In STEP 1, human image 82 and background image 83 are obtained from a computer memory. In STEP 1A, a relative size of human image 82 with respect to background image 83 is changed by a signal of sensor 200. In STEP 2, an image generated by composing background image 83 behind or in the background of human image 82 is displayed or output on picture display device 80, and then the program ends.

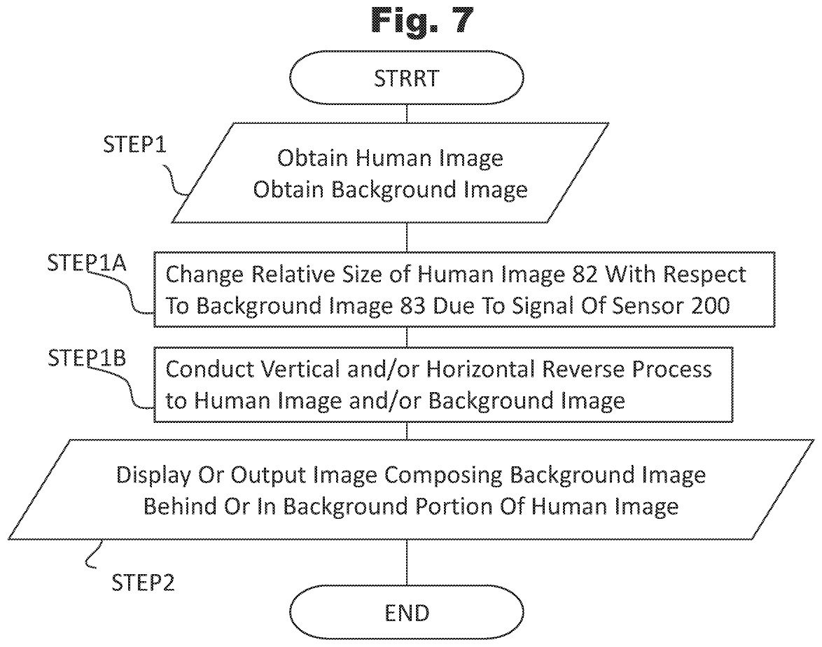

FIG. 7 shows a flowchart of another computer program used in space expansion beverage glass 1 of the present invention.

In STEP 1, human image 82 and background image 83 are obtained from a computer memory. In STEP 1A, a relative size of human image 82 with respect to background image 83 is changed by a signal of sensor 200. In STEP 1B, human image 82 or background image 83 is vertically reversed and/or horizontally reversed (conducting vertical/horizontal reverse process). In STEP 2, an image generated by composing background image 83 behind or in the background portion of human image 82 is displayed or output on picture display device 80, and then the program ends.

The process of changing the relative size in STEP 2 is described below in detail. First, the center point of human image 82 is determined, and the image is enlarged or reduced by a specified percentage (%) based on the center point. Next, the center point of background image 83 is determined, and the human image and the background image are arranged so that the center points of background image 83 and the enlarged or reduced human image overlap.

The computer programs of flowcharts shown in FIGS. 5, 6 and 7 may be stored in common storage media such as flash memory, DRAM, magnetic storage media, and optical storage media. Alternatively, these programs may be installed (stored) in the form of application software in a memory in the same housing as picture display device 80. The algorithms of the computer program of the flowcharts shown in FIGS. 5, 6 and 7 are examples, and other algorithms may be used.

### INDUSTRIAL APPLICABILITY

The present invention relates to the space expansion beverage glass (or a space expansion beverage glass system) that is capable of freely changing the size of the space on the side or bottom of the glass body viewed from the user's eyes, and it is possible for the user to communicate interactively with the fictitious character in the vast pseudo-space inside the glass body by the user operating the glass body. The user can feel the unique floating sense when looking into the glass body due to the interaction between the vast space at the bottom of the glass body, which is expanded using the reflecting mirror and the image that create the illusion of perspective of user and the alcoholic beverage. As described above, the present invention has industrial applicability.

### DESCRIPTION OF SYMBOLS

U user
U2 user
L beverage (liquid)
P. light path
a angle
1 space expansion beverage glass
10 glass body
11 upper opening
12 transparent part
15 fixing mechanism
30 reflecting minor
80 picture display device
81 picture display surface
82 human image
83 background image
85 composite image
100 image control part
200 sensor(s)

What is claimed is:

1. A space expansion beverage glass, comprising:
a glass body that is a bottomed tubular body with an upper opening,
a fixing mechanism that is configured to fix a picture display device to a side of the glass body,
a transparent part that is made of a transparent material allowing a user to view an image of the picture display device from an outside of the glass body,
an image control part that is configured to display or output a human image and a background image to the picture display device, and
a sensor, wherein
the human image is a computer graphic image representing a human or a fictitious human having a face including eyes and a mouth,
the image control part displays or outputs a composite image in which the background image is combined with a background portion of the human image to the picture display device,
in the composite image, the human image is drawn in an area where the human image and the background image overlap,
a size of the human image relative to the background image is changed due to a signal from the sensor,
the user views the composite image through a beverage inside the glass body and the transparent part.

2. The space expansion beverage glass according to claim 1, further comprising:
a reflecting minor that is configured to reflect the composite image in a direction of the upper opening, and is provided inside the glass body or near a bottom of the glass body, wherein
after the composite image is reflected off the reflecting minor, the composite image reaches an outside of the glass body through the upper opening.

3. The space expansion beverage glass according to claim 2, wherein
the reflecting minor is attached to the bottom of the glass body.

4. The space expansion beverage glass according to claim 1, wherein
the sensor is configured to monitor an operation of the user on the glass body or the picture display device,
when the sensor detects a predetermined operation on the glass body or the picture display device, the sensor transmits the signal to the image control part, and
the image control part changes the size of the human image relative to the background image in response to the signal.

5. The space expansion beverage glass according to claim 1, wherein
the image control part is computer software or a computer program.

6. The space expansion beverage glass according to claim 1, wherein
the image control part is computer software or a computer program that is implemented inside a housing of the picture display device, and
the image control part changes the composite image in correspondence with a value of signal of the sensor.

7. The space expansion beverage glass according to claim 1, wherein
the sensor is one of a camera sensor, an acceleration sensor, a microphone, a piezoelectric sensor, a touch panel, a sugar level sensor, and an alcohol sensor.

8. The space expansion beverage glass according to claim 1, wherein
the sensor is an acceleration sensor that is configured to detect acceleration of the glass body,
when the acceleration sensor detects a predetermined acceleration of the glass body, the acceleration sensor transmits the signal to the image control part, and
the image control part changes the size of the human image relative to the background image in response to the signal.

9. The space expansion beverage glass according to claim 1, wherein
the background image is an image in which a color is used, having either lower luminance or lower brightness compared to the human image.

10. The space expansion beverage glass according to claim 1, wherein
the reflecting minor is arranged such that the reflecting mirror faces parallel to the picture display surface, which is arranged in the same direction as a longitudinal direction of the glass, and the reflecting mirror tilts at about 45 degrees with respect to the picture display surface from a lateral viewpoint.

11. A storage medium storing a computer program used in the space expansion beverage glass according to claim 1, wherein
the computer program displays or outputs the composite image in which the background image is composited behind or in a background portion of the human image.

12. A storage medium storing a computer program used in the space expansion beverage glass according to claim 1, wherein
the computer program changes a size of the human image relative to the background image due to a signal of the sensor, and
the computer program displays or outputs the composite image in which the background image is composited behind or in a background portion of the human image.

13. A storage medium storing a computer program used in the space expansion beverage glass according to claim 1, wherein
the computer program changes a size of the human image relative to the background image due to a signal of the sensor,
the computer program reverses the human image and the background image vertically or horizontally, and
the computer program displays or outputs the composite image in which the background image is composited behind or in a background portion of the human image.

14. A storage medium storing a computer program used in the space expansion beverage glass according to claim 1, wherein
the computer program changes a size of the human image relative to the background image due to a signal of the sensor,
the computer program reverses the human image and the background image vertically and horizontally, and
the computer program displays or outputs the composite image in which the background image is composited behind or in a background portion of the human image.
